(19) United States
(12) Patent Application Publication
(10) Pub. No.: US 2021/0204492 A1
(43) Pub. Date: Jul. 8, 2021

(54) EMITTER AND DRIP IRRIGATION TUBE

(71) Applicant: Enplas Corporation, Saitama (JP)

(72) Inventor: Masahiro KIDACHI, Saitama (JP)

(73) Assignee: Enplas Corporation, Saitama (JP)

(21) Appl. No.: 16/650,409

(22) PCT Filed: Sep. 20, 2018
(86) PCT No.: PCT/JP2018/034704

§ 371 Date: Mar. 25, 2020

(30) Foreign Application Priority Data
Sep. 26, 2017 (JP) 2017-185188

(51) Int. Cl. A01G 25/02

(52) U.S. Cl. CPC A01G 25/023

(57) ABSTRACT

This emitter has an emitter main body comprising a first face, a second face disposed on the opposite side from the first face, and a side face connecting the first face and the second face; a water intake unit for taking in irrigation liquid disposed on the first face side; a discharge unit for discharging irrigation liquid disposed on the second face side; a flow path that connects the water intake unit and the discharge unit and allows the irrigation liquid to pass therethrough; and a protrusion disposed on the side face.

### TECHNICAL FIELD

The present invention relates to an emitter and a drip irrigation tube.

### BACKGROUND ART

A drip irrigation method is known as a plant cultivation method. In the drip irrigation method, a drip irrigation tube is placed on or in the soil where plants are planted, and irrigation liquid such as water and liquid fertilizer is dropped from the drip irrigation tube to the soil. The drip irrigation method has been increasingly attracting attention in recent years since the method can minimize the consumption of the irrigation liquid.

Normally, a drip irrigation tube includes a tube in which a plurality of through holes for discharging irrigation liquid are formed, and a plurality of emitters (also called “drippers”) for discharging the irrigation liquid from respective through holes (see, for example, PTL 1).

The emitter disclosed in PTL 1 includes a first member including a liquid inlet for receiving irrigation liquid, a second member including an outlet for discharging the irrigation liquid, and a film member disposed between the first member and the second member. The emitter is formed by stacking the first member, the film member and the second member in this order. The emitter disclosed in PTL 1 has a substantially cuboid shape, and has an external shape that is substantially symmetric in the longitudinal direction of the emitter (the axis direction of the tube), and in the width direction of the emitter. On the other hand, the internal structure of the emitter disclosed in PTL 1 is substantially symmetric in the width direction of the emitter, but is asymmetric in the longitudinal direction of the emitter (the axis direction of the tube).

### CITATION LIST

### Patent Literature

### PTL 1

### Japanese Patent Application Laid-Open No. 2010-46094

### SUMMARY OF INVENTION

### Technical Problem

A drip irrigation tube is manufactured in such a manner that, emitters are placed and joined at a predetermined interval in a tube in which no through hole is formed, and thereafter through holes are formed in the tube at positions corresponding to the outlets of the emitters, for example. In the case where an emitter whose outlet is located at a position shifted from the center of the emitter as in the emitter disclosed in PTL 1 is used, it is necessary to align the orientations of a plurality of emitters when disposing the emitters to the tube. The reason for this is that if the orientations of a plurality of emitters are not aligned, the outlets of the emitters can be disposed on the upstream side or on the downstream side, and then it is difficult to form through holes corresponding to the outlets of the emitters in the tube. If the orientations of the emitters disposed in the tube cannot be aligned, the productivity may be significantly reduced. However, the external shape of the emitter disclosed in PTL 1 is substantially symmetric not only in the longitudinal direction of the emitter, but also in the width direction of the emitter, and as such it is difficult to align the orientations of the emitters when disposing the emitters in the tube.

In view of this, an object of the present invention is to provide an emitter and a drip irrigation tube including the emitter in which the orientation in the longitudinal direction can be readily aligned in the manufacturing process of the drip irrigation tube.

### Solution to Problem

To solve the above-mentioned problems, an emitter according to the present invention is configured to discharge irrigation liquid of a tube when the emitter is disposed at a position corresponding a discharging port configured to communicate inside and outside of the tube, the emitter being configured to discharge the irrigation liquid from the discharging port, the tube being configured to carry the irrigation liquid, the emitter including an emitter main body including a first surface, a second surface disposed opposite the first surface, and a side surface connecting between the first surface and the second surface; a liquid intake part disposed in the first surface of the emitter main body and configured to receive the irrigation liquid; a discharging part disposed in the second surface of the emitter main body and configured to discharge the irrigation liquid; a channel connecting between the liquid intake part and the discharging part in the emitter main body and configured to distribute the irrigation liquid; and a protrusion disposed in a part of the side surface.

To solve the above-mentioned problems, a drip irrigation tube according to the present invention includes a tube; and the emitter according to any one of claims 1 to 4, the emitter being disposed in the tube.

### Advantageous Effects of Invention

With the emitter according to an embodiment of the present invention, the orientation of the emitter in the longitudinal direction can be readily aligned in the manufacturing process of the drip irrigation tube, and it is therefore possible to increase productivity of the drip irrigation tube.

### BRIEF DESCRIPTION OF DRAWINGS

FIGS. 1A and 1B illustrate a configuration of a drip irrigation tube according to Embodiment 1;

FIGS. 2A and 2B are perspective views illustrating a configuration of an emitter according to Embodiment 1;

FIGS. 3A to 3D illustrate a configuration of the emitter according to Embodiment 1;

FIGS. 4A and 4B are drawings for describing a conveyance step;

FIGS. 5A to 5D are drawings for describing a conveyance step;

FIGS. 6A to 6C are plan views illustrating a configuration of an emitter according to a modification of Embodiment 1;

FIGS. 7A and 7B are perspective views illustrating a configuration of an emitter according to Embodiment 2;

FIGS. 8A to 8D illustrate a configuration of the emitter according to Embodiment 2;

FIGS. 9A and 9B are drawings for describing a conveyance step;

FIGS. 10A to 10D are drawings for describing a conveyance step; and

FIGS. 11A to 11C are plan views illustrating a configuration of an emitter according to a modification of Embodiment 2.

### DESCRIPTION OF EMBODIMENTS

An emitter and a drip irrigation tube according to an embodiment of the present invention are elaborated below with reference to the accompanying drawings.

### Embodiment 1

### Configurations of Drip Irrigation Tube and Emitter

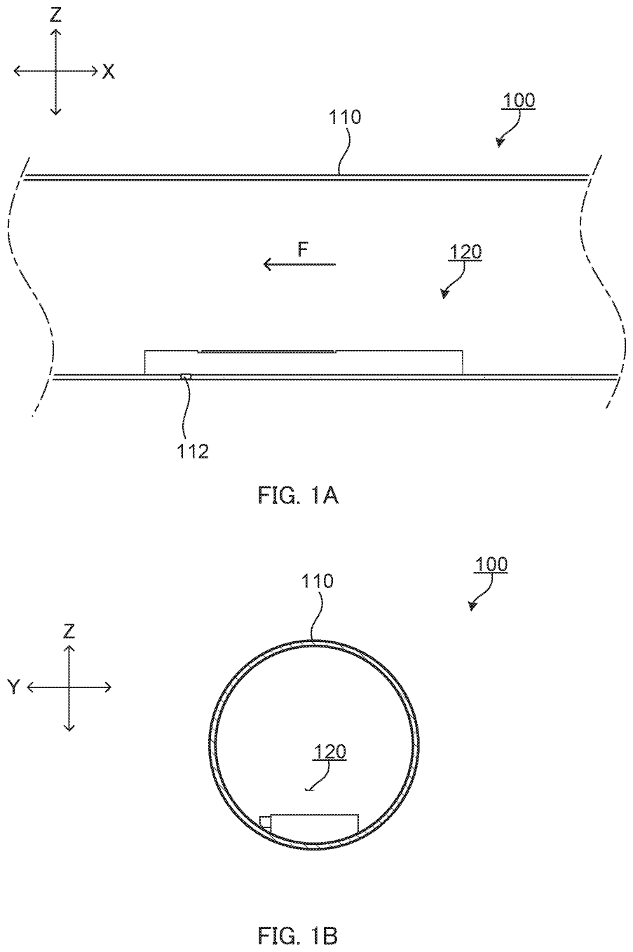

FIGS. 1A and 1B illustrate a configuration of drip irrigation tube 100 according to Embodiment 1. FIG. 1A is a perspective view taken along the longitudinal axial direction of drip irrigation tube 100, and FIG. 1B is a sectional view taken along the minor axis direction of drip irrigation tube 100. Note that, in FIGS. 1A and 1B, only a cross section of tube 110 is illustrated and the emitter is illustrated as a conceptual view. In addition, arrow F in FIG. 1A indicates the flow direction of irrigation liquid in tube 110.

As illustrated in FIGS. 1A and 1B, drip irrigation tube 100 includes tube 110 and emitter 120. Note that, in the following description, the axis direction of tube 110 or the longitudinal direction of emitter 120 is the X direction, and the short (width) direction of emitter 120 is the Y direction, and the height direction of the emitter 120 is the Z direction.

Tube 110 is a pipe configured to distribute irrigation liquid. The material of tube 110 is not limited. In the present embodiment, the material of tube 110 is polyethylene. The cross-sectional shape of tube 110 in the minor axis direction is a circular shape, for example.

Emitters 120 are disposed at a predetermined interval (e.g., 200 to 500 mm) in the axis direction of tube 110 (X direction). Emitter 120 is joined to the inner surface of tube 110. Emitter 120 is disposed at a position that covers discharging port 112 of tube 110.

Discharging port 112 is a hole extending through the pipe wall of tube 110. The hole diameter of discharging port 112 is, for example 1.5 mm.

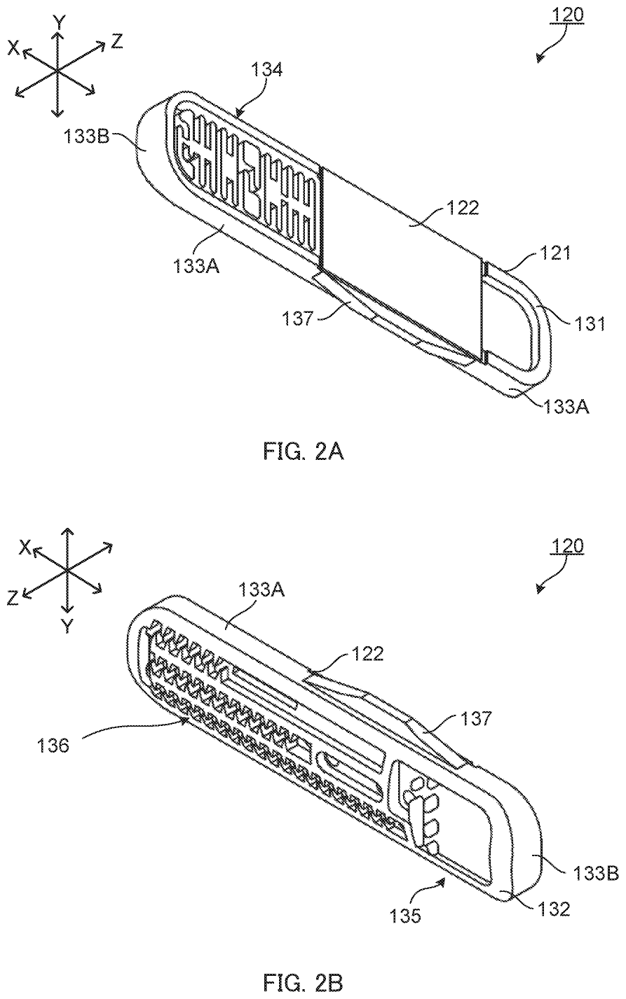

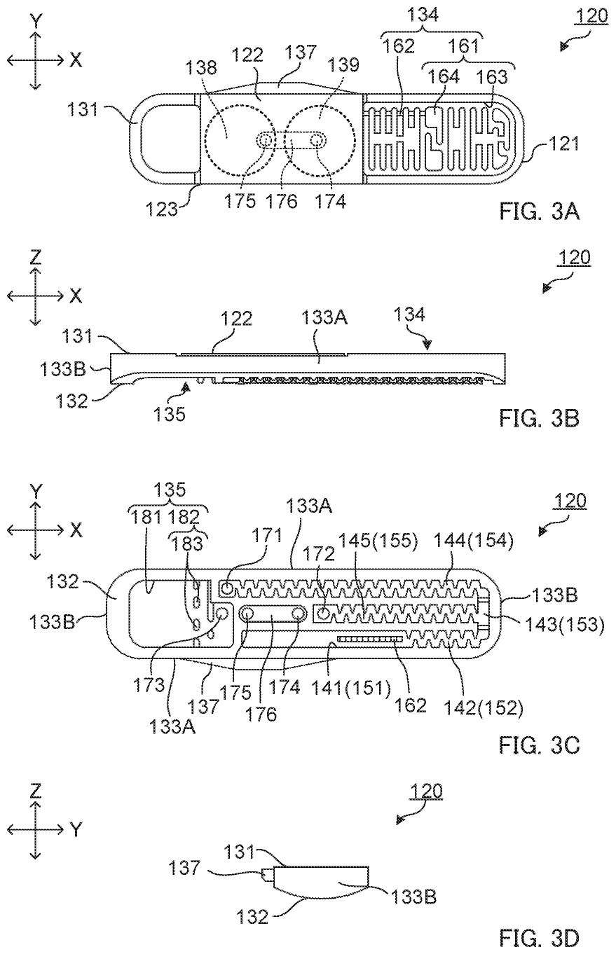

FIGS. 2A to 3D illustrate a configuration of emitter 120. FIG. 2A is a perspective view of emitter 120 as viewed from first surface 131 side, and FIG. 2B is a perspective view of emitter 120 as viewed from second surface 132 side. FIG. 3A is a plan view of emitter 120, FIG. 3B is a front view of emitter 120, FIG. 3C is a bottom view of emitter 120, and FIG. 3D is a left side view of emitter 120.

As illustrated in FIGS. 2A to 3D, the planar shape (the shape as viewed along the Z direction) of emitter 120 (emitter main body 121 described later) can be appropriately set. Examples of the shape of emitter 120 in plan view include a circular shape, an ellipse shape, a polygonal shape, and a substantially polygonal shape. In the present embodiment, emitter 120 has a substantially rectangular shape in plan view. The “substantially rectangular shape” means a shape whose corners are chamfered into a round shape. In the present embodiment, emitter 120 (emitter main body 121) has a substantially rectangular shape with chamfered round corners in plan view. For example, the length of emitter 120 is 26 mm in the X direction, 10 mm in the Y direction, and 2.5 mm in the Z direction.

Emitter 120 includes emitter main body 121, liquid intake part 134, discharging part 135, channel groove 136, and protrusion 137. In addition to the above-mentioned configurations, emitter 120 includes film 122, flow rate reducing part 138, and channel opening-closing part 139. Emitter main body 121 and film 122 may be integrated with each other, or may be formed as separate members. In the present embodiment, emitter main body 121 and film 122 are integrated with each other with hinge part 123 therebetween.

Preferably, emitter main body 121 and film 122 are formed with one material having flexibility. In the case where emitter main body 121 and film 122 are formed as separated members, emitter main body 121 may be formed using a material that does not have flexibility.

Examples of the material of emitter main body 121 and film 122 include resin and rubber. Examples of the resin include polyethylene and silicone. The flexibility of emitter main body 121 and film 122 can be adjusted by use of an elastic resin material. Examples of the way of adjusting the flexibility of emitter main body 121 and film 122 include selection of an elastic resin material, and adjustment of the mixing ratio of an elastic resin material to a hard resin material. An integral molded article of emitter main body 121 and film 122 can be manufactured by injection molding, for example.

Emitter main body 121 includes first surface (upper surface) 131, second surface (lower surface) 132, and side surfaces (two first side surfaces 133A and two second side surfaces 133B). First surface 131 is one surface in the Z direction, and makes contact with irrigation liquid flowing through drip irrigation tube 100. Second surface 132 is a surface disposed on the side opposite to first surface 131 (the other surface in the Z direction), and is joined to the inner surface of tube 110. Two first side surfaces 133A and two second side surfaces 133B are surfaces extending along the Z direction, and connect first surface 131 and second surface 132.

Two first side surfaces 133A are opposite each other in the first direction (Y direction). Second side surfaces 133B are opposite each other in the second direction (X direction). The length of each of two first side surfaces 133A in the second direction is greater than the length of each of two second side surfaces 133B in the first direction. Protrusion 137 is disposed in one first side surface 133A of two first side surfaces 133A. That is, protrusion 137 is not disposed in the other first side surface 133 of two first side surfaces 133A. Note that, in the case where the length of first side surface 133A in the second direction and the length of second side surface 133B in the first direction are equal to each other, it suffices to dispose protrusion 137 in one first side surface 133A or one second side surface 133B of two first side surfaces 133A and two second side surfaces 133B.

Channel groove 136 includes first connecting groove 141 serving as first connecting channel 151, first pressure reducing groove 142 serving as first pressure reducing channel 152, second connecting groove 143 serving as second connecting channel 153, second pressure reducing groove 144 serving as second pressure reducing channel 154, and third pressure reducing groove 145 serving as third pressure reducing channel 155.

Liquid intake part 134, flow rate reducing part 138 and channel opening-closing part 139 are disposed on first surface 131 side in emitter main body 121. First connecting groove 141, first pressure reducing groove 142, second connecting groove 143, second pressure reducing groove 144, third pressure reducing groove 145, and discharging part 135 are disposed on second surface 132 side in emitter main body 120. Protrusion 137 is disposed in one first side surface 133A of two first side surfaces 133A (in FIG. 3A, first side surface 133A on the upper side). Protrusion 137 is not disposed in the other first side surface 133A (in FIG. 3A, first side surface 133A on the lower side).

When emitter 120 is joined to the inner surface of tube 110, first connecting groove 141, first pressure reducing groove 142, second connecting groove 143, second pressure reducing groove 144 and third pressure reducing groove 145 serve as first connecting channel 151, first pressure reducing channel 152, second connecting channel 153, second pressure reducing channel 154 and third pressure reducing channel 155, respectively. With this configuration, a first channel that is composed of liquid intake part 134, first connecting channel 151, first pressure reducing channel 152, second connecting channel 153, second pressure reducing channel 154, flow rate reducing part 138 and discharging part 135, and connects between liquid intake part 134 and discharging part 135 is formed. In addition, a second channel that is composed of liquid intake part 134, first connecting channel 151, first pressure reducing channel 152, second connecting channel 153, third pressure reducing channel 155, channel opening-closing part 139, flow rate reducing part 138 and discharging part 135, and connects between liquid intake part 134 and discharging part 135 is formed.

Liquid intake part 134 is disposed in an approximately half region of first surface 131 of emitter main body 121 (see FIG. 3A). In a region of first surface 131 where liquid intake part 134 is not disposed, flow rate reducing part 138 and channel opening-closing part 139 are disposed, and this region is partially covered with film 122. Liquid intake part 134 includes liquid intake side screening part 161 and intake through hole 162.

Liquid intake side screening part 161 prevents entry, into intake recess 163, of foreign matters in irrigation liquid taken into emitter 120. Liquid intake side screening part 161 is open toward the interior of tube 110, and includes intake recess 163 and a plurality of ridges 164.

Intake recess 163 is a single recess formed in first surface 131 of emitter main body 121 in the entirety of the region where film 122 is not joined. The plurality of ridges 164 are formed on the bottom surface of intake recess 163. In addition, intake through hole 162 is formed in the bottom surface of intake recess 163.

The plurality of ridges 164 is disposed on the bottom surface of intake recess 163. The installation position and number of ridges 164 are not limited as long as liquid intake part 134 can draw irrigation liquid from the opening side of intake recess 163 while preventing entry of foreign matters in the irrigation liquid to a certain degree. In the present embodiment, the plurality of ridges 164 is arranged such that the longitudinal direction of each ridge 164 is aligned with the short direction of emitter main body 121.

Intake through hole 162 is formed in the bottom surface of intake recess 163. The shape and the number of intake through hole 162 are not limited as long as the irrigation liquid taken into intake recess 163 can be taken into emitter 120. In the present embodiment, intake through hole 162 is a single long hole that is formed in the bottom surface of intake recess 163 and is extended along the longitudinal direction of emitter 120.

Irrigation liquid flown through the inside of tube 110 is taken into emitter 120 while entry of foreign matters into intake recess 163 is prevented by liquid intake side screening part 161 to a certain degree.

First connecting groove 141 (first connecting channel 151) connects between liquid intake part 134 and first pressure reducing groove 142. First connecting groove 141 is formed in a linear shape along the longitudinal direction of emitter 120 at the outer edge of second surface 132. When the opening of first connecting groove 141 on second surface 132 side is covered with tube 110, first connecting channel 151 is formed. Irrigation liquid taken from liquid intake part 134 flows to first pressure reducing channel 152 through first connecting channel 151.

First pressure reducing groove 142 (first pressure reducing channel 152) is disposed in the second channel and the first channel upstream of flow rate reducing part 138, and connects between first connecting groove 141 (first connecting channel 151) and second connecting groove 143 (second connecting channel 153). First pressure reducing groove 142 (first pressure reducing channel 152) reduces the pressure of irrigation liquid taken from liquid intake part 134, and guides the liquid to second connecting groove 143 (second connecting channel 153). First pressure reducing groove 142 is disposed in a linear shape along the longitudinal direction of emitter 120 at the outer edge of second surface 132. The upstream end of first pressure reducing groove 142 is connected to first connecting groove 141, and the downstream end of first pressure reducing groove 142 is connected to the upstream end of second connecting groove 143. First pressure reducing groove 142 has a zigzag shape in plan view. When the opening of first pressure reducing groove 142 on second surface 132 side is covered with tube 110, first pressure reducing channel 152 is formed. The pressure of irrigation liquid taken from liquid intake part 134 is reduced by first pressure reducing channel 152 and then the liquid is guided to second connecting groove 143 (second connecting channel 153).

Second connecting groove 143 (second connecting channel 153) connects between first pressure reducing groove 142 (first pressure reducing channel 152) and second pressure reducing groove 144 (second pressure reducing channel 154) and third pressure reducing groove 145 (third pressure reducing channel 155). Second connecting groove 143 is formed in a linear shape along the short direction of emitter 120 at the outer edge of second surface 132. When the opening of second connecting groove 143 on second surface 132 side is covered with tube 110, second connecting channel 153 is formed. The irrigation liquid that is taken from liquid intake part 134 and guided to first connecting channel 151 such that the pressure thereof is reduced by first pressure reducing channel 152 is guided to second pressure reducing channel 154 and third pressure reducing channel 155 through second connecting channel 153.

Second pressure reducing groove 144 (second pressure reducing channel 154) is disposed in the first channel upstream of flow rate reducing part 138, and connects between second connecting groove 143 (second connecting channel 153) and flow rate reducing part 138. Second pressure reducing groove 144 (second pressure reducing channel 154) reduces the pressure of the irrigation liquid flowing from second connecting groove 143 (second connecting channel 153), and guides the liquid to flow rate reducing part 138. Second pressure reducing groove 144 is disposed along the longitudinal direction of emitter 120 at the outer edge of second surface 132. The upstream end of second pressure reducing groove 144 is connected to the upstream end of second connecting groove 143, and the downstream end of second pressure reducing groove 144 is connected to first connecting through hole 171 communicated with flow rate reducing part 138. The shape of second pressure reducing groove 144 is not limited as long as the above-described function can be ensured. In the present embodiment, in plan view, second pressure reducing groove 144 has a zigzag shape similar to the shape of first pressure reducing groove 142. When the opening of second pressure reducing groove 144 on second surface 132 side is covered with tube 110, second pressure reducing channel 154 is formed. A part of the irrigation liquid whose pressure has been reduced by first pressure reducing channel 152 after being taken from liquid intake part 134 is guided to flow rate reducing part 138 while the pressure thereof is reduced by second pressure reducing channel 154.

Third pressure reducing groove 145 (third pressure reducing channel 155) is disposed in the second channel upstream of flow rate reducing part 138, and connects between second connecting groove 143 (second connecting channel 153) and channel opening-closing part 139. Third pressure reducing groove 145 (third pressure reducing channel 155) reduces the pressure of the irrigation liquid flowing from second connecting groove 143 (second connecting channel 153), and guides the liquid to channel opening-closing part 139. Third pressure reducing groove 145 is disposed along the longitudinal direction of emitter 120 at a center portion of second surface 132. The upstream end of third pressure reducing groove 145 is connected to the downstream end of second connecting channel 153, and the downstream end of third pressure reducing groove 145 is connected to second connecting through hole 172 communicated with channel opening-closing part 139. The shape of third pressure reducing groove 145 is not limited as long as the above-described function can be ensured. In the present embodiment, in plan view, third pressure reducing groove 145 has a zigzag shape similar to the shape of first pressure reducing groove 142. When the opening of third pressure reducing groove 145 on second surface 132 side is covered with tube 110, third pressure reducing channel 155 is formed. The other part of the irrigation liquid whose pressure has been reduced by first pressure reducing channel 152 after being taken liquid intake part 134 is guided to channel opening-closing part 139 while the pressure thereof is reduced by third pressure reducing channel 155.

Flow rate reducing part 138 is disposed between second pressure reducing channel 154 (second pressure reducing groove 144) and discharging part 135 in the first channel, on first surface 131 side in emitter 120. Flow rate reducing part 138 sends the irrigation liquid to discharging part 135 while reducing the flow rate of the irrigation liquid in accordance with the pressure of the irrigation liquid in tube 110.

Channel opening-closing part 139 is disposed between third pressure reducing channel 155 (third pressure reducing groove 145) and discharging part 135 in the second channel, on first surface 131 side in emitter 120. Channel opening-closing part 139 opens the second channel in accordance with the pressure in tube 110 to send the irrigation liquid to discharging part 135.

Flow rate reducing part 138 and channel opening-closing part 139 are communicated with each other through first communication hole 174, second communication hole 175 and communication path 176.

Discharging part 135 is disposed on second surface 132 side in emitter 120. Discharging part 135 sends, to discharging port 112 of tube 110, the irrigation liquid from flow rate reducing through hole 173. With this configuration, discharging part 135 can discharge the irrigation liquid to the outside of emitter 120. The configuration of discharging part 135 is not limited as long as the above-described function can be ensured. In the present embodiment, discharging part 135 includes discharging recess 181 and entry preventing part 182.

Discharging recess 181 is disposed on second surface 132 side in the emitter. In plan view, discharging recess 181 has a substantially rectangular shape. In the bottom surface of discharging recess 181, flow rate reducing through hole 173 and entry preventing part 182 are disposed. The opening of discharging recess 181 on second surface 132 side is covered with tube 110.

Entry preventing part 182 prevents entry of foreign matters from outside of tube 110. Entry preventing part 182 is not limited as long as the above-described function can be ensured. In the present embodiment, entry preventing part 182 includes a plurality of ridges 183 disposed next to each other. Ridges 183 are disposed between flow rate reducing through hole 173 and discharging port 112.

Hinge part 123 is connected to a part of first surface 131 of emitter main body 121. In the present embodiment, the thickness of hinge part 123 is identical to the thickness of film 122, and hinge part 123 is formed integrally with emitter main body 121 and film 122. Preferably, hinge part 123 is disposed at an end portion of emitter main body 121 on the side opposite to protrusion 137. It is to be noted that film 122 may be prepared as a separate member that is separated from emitter main body 121, and may be joined to emitter main body 121.

Emitter 120 serves its function when film 122 is turned about hinge part 123 and joined to first surface 131 of emitter main body 121. The method of joining emitter main body 121 and film 122 is not limited. Examples of the method of joining emitter main body 121 and film 122 include welding of the resin material of film 122, bonding with an adhesive agent, and the like. Note that, in the case where hinge part 123 is disposed at an end portion of emitter main body 121 on the side opposite to protrusion 137, hinge part 123 is cut and removed from emitter main body 121 after emitter main body 121 and film 122 are joined to each other.

Protrusion 137 is disposed in only one of two first side surfaces 133A. Specifically, protrusion 137 is disposed in first side surface 133A extended in the direction along the flow direction of the irrigation liquid in tube 110. In the present embodiment, protrusion 137 is disposed in side surface 133 on first connecting groove 141 side, which is a side surface in the minor axis direction of emitter 120 (Y direction). In the present embodiment, protrusion 137 is disposed on discharging part 134 side relative to the center portion in the X direction in the first side surface 133A. The shape of protrusion 137 is not limited as long as emitter 120 whose orientation is improper can be easily eliminated in the method of manufacturing drip irrigation tube 100 described later. In the present embodiment, in plan view, protrusion 137 has a trapezoidal column shape whose bottom side is located on first side surface 133A side. The number of protrusions 137 disposed in one first side surface 133A is also not limited. In the present embodiment, one protrusion 137 is provided. It should be noted that, as described above, no protrusion 137 is disposed in the other first side surface 133A. As described above, the shape in plan view of emitter 120 according to the present embodiment is laterally and vertically asymmetric.

### Method of Manufacturing Drip Irrigation Tube

Drip irrigation tube 100 according to the present embodiment can be manufactured by the following method using emitter 120, for example. In manufacture of drip irrigation tube 100, a sheet member using a material for the tube 100 is continuously manufactured, emitters 120 are continuously joined at predetermined positions of the sheet member serving as the inner surface of tube 110, and the ends of the sheet member are continuously joined together.

First, a long sheet member is continuously manufactured by a T-die method or the like using a melted tube material. At this time, before the sheet member is cured, emitters 120 are continuously disposed at predetermined positions in the inner surface of tube 110. When the sheet member is cured, emitters 120 disposed at predetermined positions are joined thereto. In addition, both ends of the sheet member on which emitter 120 is disposed is joined to each other before the sheet member is cured. Finally, discharging holes 112 are formed at predetermined positions in tube 110.

As described above, formation of tube 110 and joining of emitter 120 to the sheet member are almost simultaneously and continuously performed. As such, it is necessary to continuously supply emitter 120 in a proper orientation. Emitter 120 manufactured by injection molding or the like is conveyed while being controlled in a proper orientation.

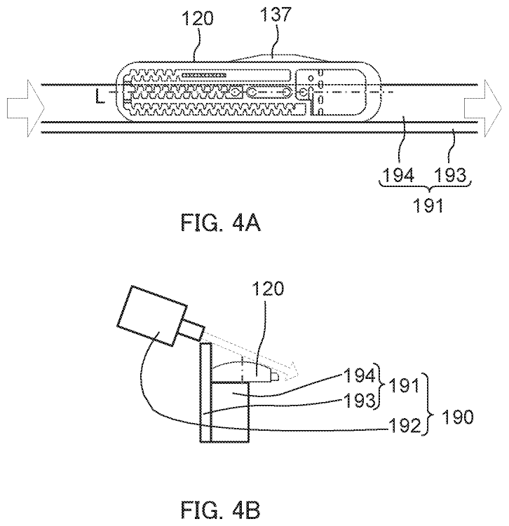

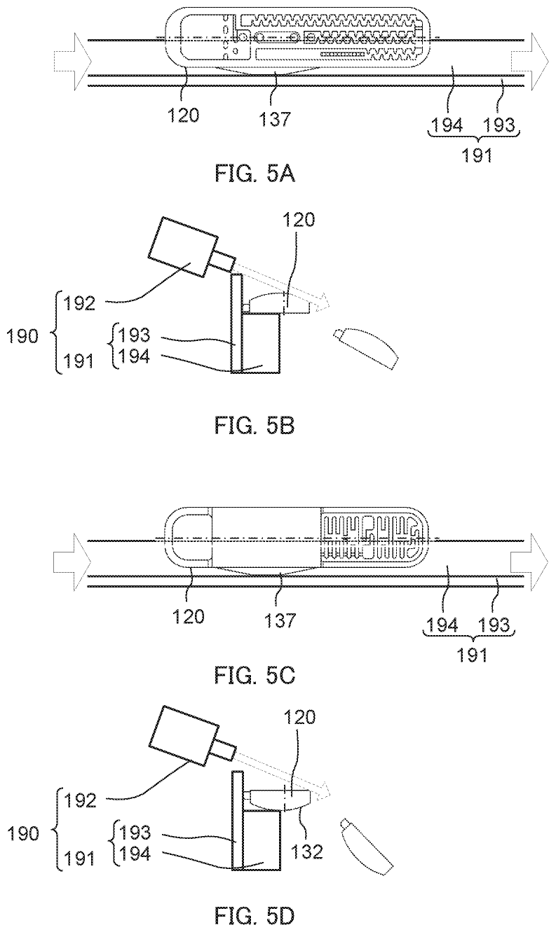

FIGS. 4A to 5D are drawings for describing a method of eliminating emitter 120 whose orientation is improper during conveyance. FIG. 4A illustrates properly orientated emitter 120 that is being conveyed as viewed from above, and FIG. 4B is a drawing illustrating the same state as viewed from the downstream side in the conveyance direction. FIG. 5A illustrates a state where emitter 120 whose orientation is improper (reversed in the front-rear direction) is eliminated during conveyance as viewed from above, and FIG. 5B is a drawing illustrating the same state as viewed from the downstream side in the conveyance direction. In addition, FIG. 5C illustrates emitter 120 whose orientation is improper (reversed in the upper-lower direction) that is being conveyed during conveyance as viewed from above, and FIG. 5D is a drawing illustrating the same state as viewed from the downstream side in the conveyance direction. Note that, in FIGS. 4A, 5A and 5C, the one-handed arrow indicates the conveyance direction of emitter 120.

As illustrated in FIGS. 4A and 4B, conveyance apparatus 190 for conveying emitter 120 includes conveyance belt 191 and jetting apparatus 192. Conveyance belt 191 includes back plate 193 and belt main body 194. In the present embodiment, conveyance apparatus 190 conveys emitter 120 by moving belt main body 194 in the state where first surface 131 of emitter 120 is disposed on belt main body 194 and back plate 193 is in contact with first side surface 133A provided with no protrusion 137. On the assumption that emitter 120 is conveyed in a proper orientation, the width of belt main body 194 is set such that center line L (or center of gravity) of emitter main body 121 is located on belt main body 194 as illustrated in FIGS. 4A and 4B. In addition, on the assumption that emitter 120 is conveyed in an improper orientation, the width of belt main body 194 is set such that center line L (or center of gravity) of emitter main body 121 is not located on back plate 193 as illustrated in FIGS. 5A to 5D. Jetting apparatus 192 jets gas such as air toward emitter 120 from the upper side of conveyance belt 191.

As illustrated in FIGS. 4A and 4B, when emitter 120 is conveyed in a proper orientation, the distance from back plate 193 to center line L is smaller than the width of belt main body 194, and therefore emitter 120 is not eliminated from conveyance belt 191 even when jetting gas is jetted from apparatus 192.

On the other hand, as illustrated in FIG. 5A, when emitter 120 reversed in the front-rear direction is conveyed, emitter 120 is conveyed in an improper orientation with protrusion 137 located on conveyance belt 191 side. In addition, as illustrated in FIG. 5B, in emitter 120 in improper orientation reversed in the front-rear direction, the distance from back plate 193 to center line L of emitter 120 is greater than the width of belt main body 194, and thus emitter 120 is eliminated from conveyance belt 191 when gas is jetted from jetting apparatus 192.

In addition, as illustrated in FIG. 5C, also in the case where emitter 120 reversed in the front-rear direction and in the upper-lower direction is conveyed, emitter 120 is conveyed in an improper orientation with protrusion 137 located on conveyance belt 191 side. Also in this case, emitter 120 is unstably sways in the horizontal direction. In addition, as illustrated in FIG. 5D, in emitter 120 in an improper orientation reversed in the front-rear direction and in the upper-lower direction, the distance from back plate 193 to center line L of emitter 120 is greater than the width of belt main body 194, and second surface 132, which is a curved surface, is in contact with belt main body 194, and as such, emitter 120 is eliminated from conveyance belt 191 when gas is jetted from jetting apparatus 192.

Next, drip irrigation tubes according to Modifications 1 to 3 of Embodiment 1 are described. The drip irrigation tubes according to the modifications of Embodiment 1 differ from drip irrigation tube 100 according to Embodiment 1 only in configurations of protrusions 237, 337 and 437 of emitters 220, 320 and 420. Note that the components similar to the drip irrigation tube according to Embodiment 1 are designated with the same reference numerals and the description thereof will be omitted.

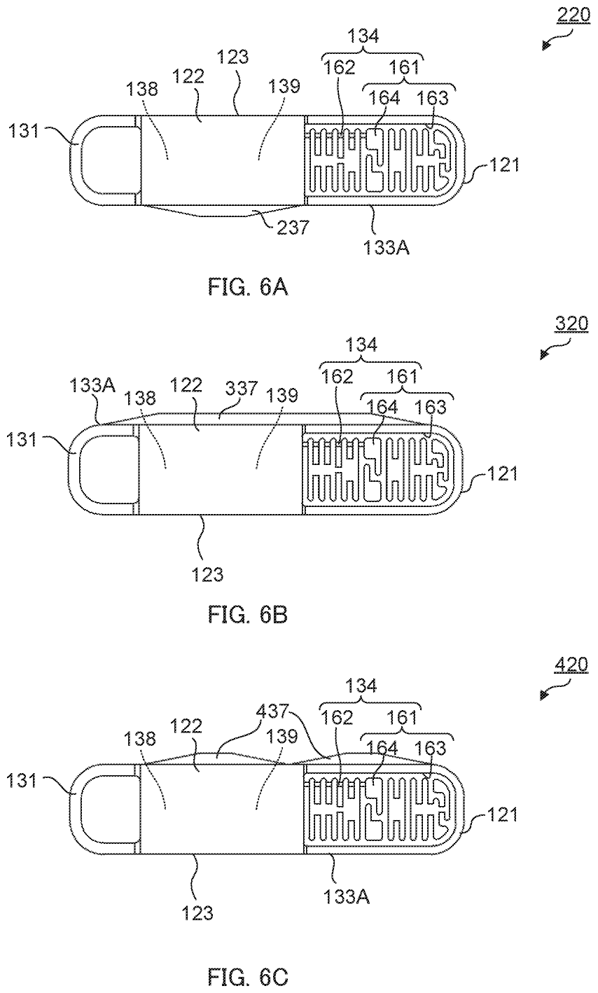

As illustrated in FIG. 6A, protrusion 237 of emitter 220 according to Modification 1 may be disposed in first side surface 133A on the side opposite to that of protrusion 137 emitter 120 according to Embodiment 1.

As illustrated in FIG. 6B, protrusion 337 of emitter 320 according to Modification 2 may be disposed over the entirety of first side surface 133A extending along the flow direction of the irrigation liquid.

As illustrated in FIG. 6C, a plurality of protrusions 437 may be provided in emitter 420 according to Modification 2. In this case, protrusions 437 may be spaced away from each other, or may adjoin each other.

### Effect

As described above, since a protrusion is disposed in first side surface 133A in drip irrigation tube 100 according to the present embodiment, emitters can be continuously provided in a proper orientation in a manufacturing process of drip irrigation tube 100. Thus, the present invention can increase the productivity of drip irrigation tube 100.

### Embodiment 2

Next, a drip irrigation tube of Embodiment 2 is described. The drip irrigation tube according to Embodiment 2 differs from drip irrigation tube 100 according to Embodiment 1 only in the configuration of emitter 520. Note that the components similar to the drip irrigation tube according to Embodiment 1 are designated with the same reference numerals and the description thereof will be omitted.

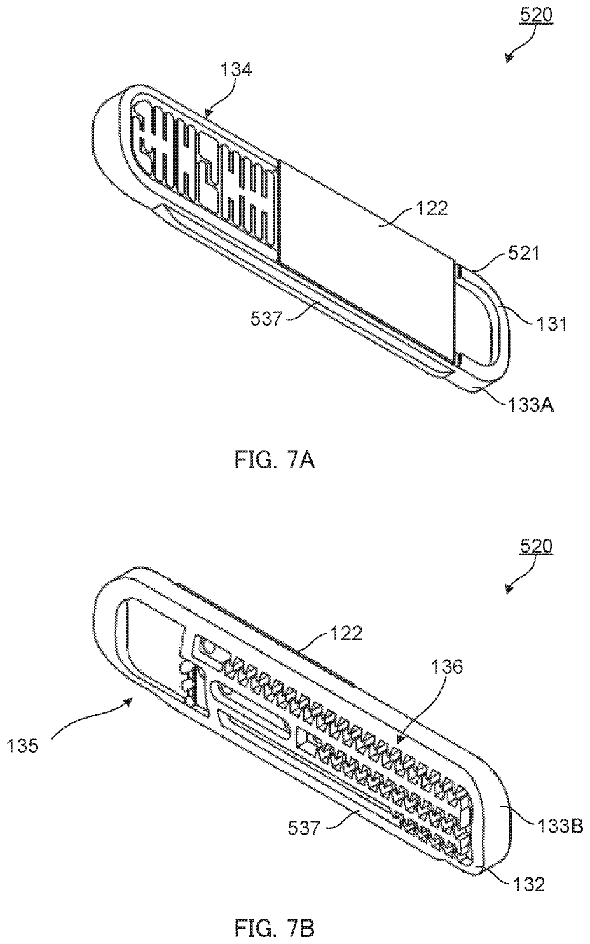

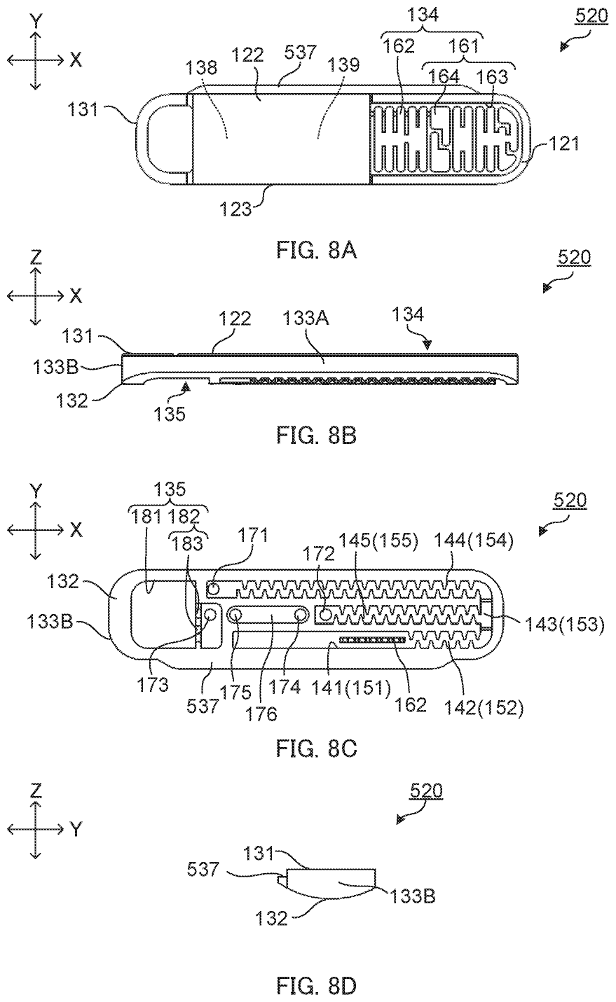

FIGS. 7A to 8D illustrate a configuration of emitter 520 according to Embodiment 2. FIG. 7A is a perspective view of emitter 520 according to Embodiment 2 as viewed from first surface 131 side, and FIG. 7B is a perspective view of emitter 520 as viewed from second surface 132 side. FIG. 8A is a plan view of emitter 520 according to Embodiment 2, FIG. 8B is a back view of emitter 520, FIG. 8C is a bottom view of emitter 520, and FIG. 8D is a left side view of emitter 520.

As illustrated in FIGS. 7A to 8D, emitter 520 according to Embodiment 2 includes emitter main body 521, liquid intake part 134, discharging part 135, channel groove 136, and protrusion 537. Second surface 132 of emitter main body 521 has the same shape as a part of the inner surface of tube 110. Specifically, second surface 132 is a curved surface that includes a ridgeline linearly extending in the X direction and has a curvature only in the Y direction.

Protrusion 537 according to the present embodiment is disposed over the entirety of first side surface 133A extending along the flow direction of the irrigation liquid. In addition, in protrusion 537, the surface on second surface 132 side has the same shape as a part of the inner surface of tube 110. Specifically, the surface of protrusion 537 on second surface 132 side is a curved surface that includes a ridgeline linearly extending in the X direction, and has a curvature only in the Y direction. In addition, the surface of protrusion 537 on second surface 132 side forms one continuous curved surface together with second surface 132.

### Method of Manufacturing Drip Irrigation Tube

A method of manufacturing drip irrigation tube according to Embodiment 2 differs only in the configuration of the conveyance apparatus due to a difference in emitter 520 from emitter 120 according to Embodiment 1.

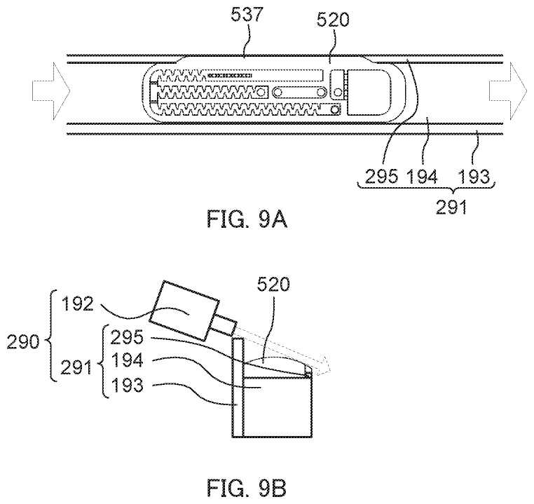

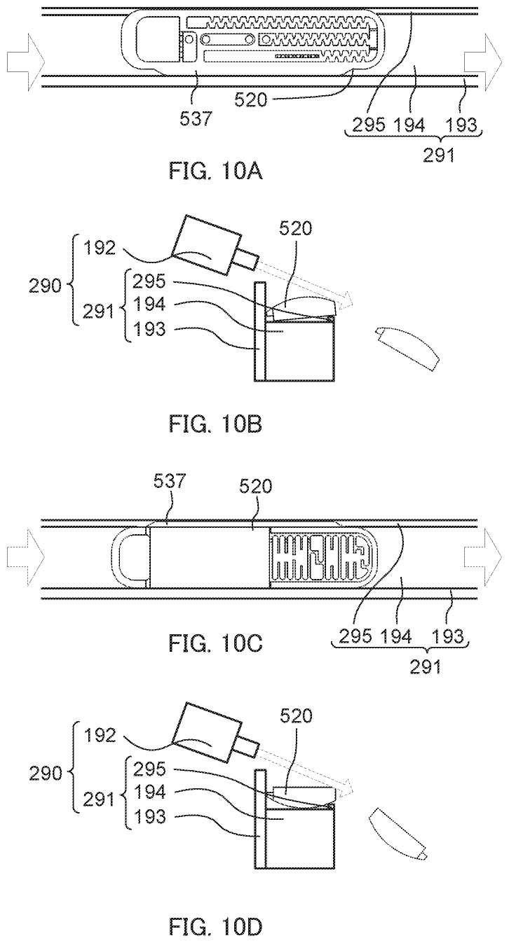

FIGS. 9A to 10D are drawings for describing a controlling method of setting emitter 520 to a predetermined orientation. FIG. 9A is a top view illustrates a state where emitter 520 maintained in a proper orientation is conveyed, and FIG. 9B illustrates this state as viewed from the conveyance direction. FIG. 10A illustrates a state where emitter 520 reversed in the front-rear direction is conveyed as viewed from the lateral side, and FIG. 10B illustrates this state as viewed from the conveyance direction. FIG. 10C is a top view of emitter 520 reversed in the upper-lower direction is conveyed, and FIG. 10D illustrates this state as viewed from the conveyance direction. Note that, in FIGS. 9A, 10A and 10C, the one-handed arrow indicates the conveyance direction of emitter 520.

As illustrated in FIGS. 9A and 9B, in a method of manufacturing a drip irrigation tube according to Embodiment 2, conveyance apparatus 290 includes conveyance belt 291 and jetting apparatus 192. Conveyance belt 291 includes back plate 193, belt main body 194, and protrusion 295 disposed at an upper end portion of belt main body 194. In the present embodiment, emitter 520 is conveyed by moving belt main body 194 in the state where second surface 132 is in intimate contact with belt main body 194, and protrusion 537 is located on the side opposite to back plate 193 and is in contact with protrusion 295. As illustrated in FIGS. 9A and 9B, the width of belt main body 194 is equal to the short axial length of emitter 520.

As illustrated in FIGS. 9A and 9B, when emitter 520 is conveyed in a proper orientation, second surface 132 is in intimate contact with fixed belt main body 194 and protrusion 137 is in contact with protrusion 295, and thus, emitter 120 is not eliminated from conveyance belt 291 even when gas is jetted from jetting apparatus 192.

On the other hand, when emitter 520 reversed in the front-rear direction is conveyed as illustrated in FIGS. 10A and 10B, or when emitter 520 reversed in the upper-lower direction is conveyed as illustrated in FIGS. 10C and 10D, the orientation is improper since first surface 131 is not in contact with belt main body 194 and protrusion 537 is not in contact with protrusion 295. When gas is jetted from jetting apparatus 192 in this state, emitter 520 is eliminated conveyance belt 191.

While only emitter 520 in a proper orientation is conveyed by conveyance apparatus 290 in the present embodiment, conveyance apparatus 190 of Embodiment 1 can also convey only emitter 520 in a proper orientation.

Next, drip irrigation tubes according to Modifications 1 to 3 of Embodiment 2 are described. Drip irrigation tubes according to Modifications 1 to 3 of Embodiment 2 differ from the drip irrigation tube according to Embodiment 2 only in configurations of protrusions 637, 737 and 837 in emitters 620, 720 and 820. Note that the components similar to the drip irrigation tube according to Embodiment 2 are designated with the same reference numerals and the description thereof will be omitted.

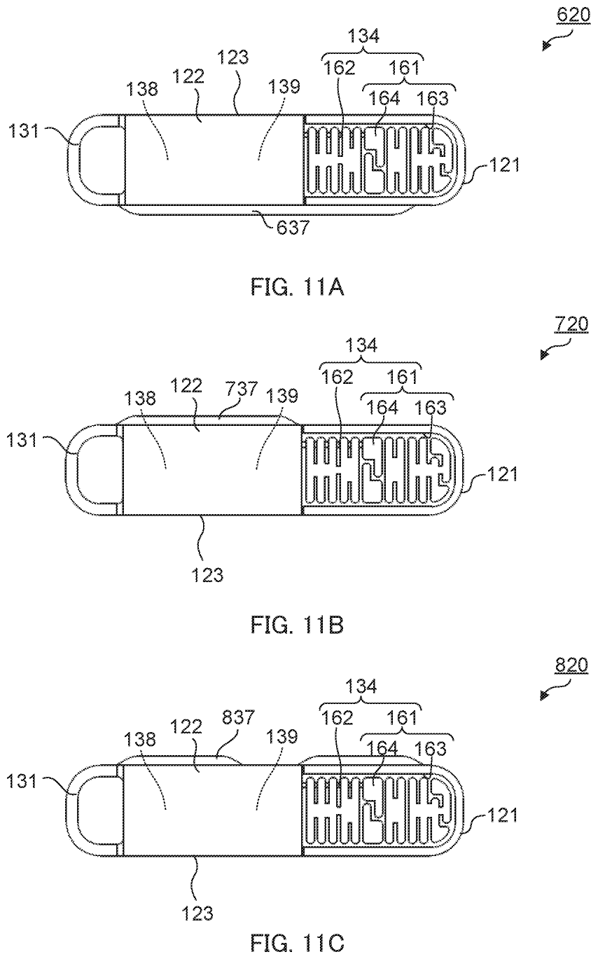

As illustrated in FIG. 11A, protrusion 637 of emitter 620 according to Modification 1 may be disposed in first side surface 133A on the side opposite to that of protrusion 537 of emitter 520 according to Embodiment 2.

As illustrated in FIG. 11B, protrusion 737 of emitter 720 according to Modification 2 may be disposed in a half range of first side surface 133A extending along the flow direction of the irrigation liquid.

As illustrated in FIG. 11C, a plurality of protrusions 837 may be provided in emitter 820 according to Modification 3. In this case, protrusions 837 may be spaced away from each other, or may adjoin each other. In the present embodiment, protrusions 837 are spaced away from each other.

### Effect

As described above, the drip irrigation tube according to the present embodiment can further increase the productivity of drip irrigation tube 100 since the contact area with the inner surface of tube 110 is large while achieving the effect of the drip irrigation tube according to Embodiment 1.

Note that, although not illustrated in the drawings, the surface on first surface 131 side of protrusions 137, 237, 337 and 437 of emitters 120, 220, 320 and 420 of Embodiment 1 may be a flat surface, and may form one surface continuous from first surface 131.

In addition, in Embodiment 2, protrusion 295 may be disposed at an end portion on belt main body 194 side of back plate 193. In this case, emitters 520, 620, 720 and 820 are conveyed in reverse in the front-rear direction.

This application is entitled to and claims the benefit of Japanese Patent Application No. 2017-185188 filed on Sep. 26, 2017, the disclosure each of which including the specification, drawings and abstract is incorporated herein by reference in its entirety.

### INDUSTRIAL APPLICABILITY

The drip irrigation tube according to the embodiments of the present invention is useful as a drip irrigation tube for use in high-temperature regions, for example.

### REFERENCE SIGNS LIST

100 Drip irrigation tube
110 Tube
112 Discharging port
120, 220, 320, 420, 520, 620, 720, 820 Emitter
121 Emitter main body
122 Film
123 Hinge part
131 First surface
132 Second surface
133A First side surface
133B Second side surface
134 Liquid intake part
135 Discharging part
136 Channel groove
137, 237, 337, 437, 537, 637, 737, 837 Protrusion
138 Flow rate reducing part
139 Channel opening-closing part
141 First connecting groove
142 First pressure reducing groove
143 Second connecting groove
144 Second pressure reducing groove
145 Third pressure reducing groove
151 First connecting channel
152 First pressure reducing channel
153 Second connecting channel
154 Second pressure reducing channel
155 Third pressure reducing channel
161 Liquid intake side screening part
162 Intake through hole
163 Intake recess
164 Ridge
171 First connecting through hole
172 Second connecting through hole
173 Flow rate reducing through hole
174 First communication hole
175 Second communication hole
176 Communication path
190, 290 Conveyance apparatus
191, 291 Conveyance belt
192 Jetting apparatus
193 Back plate
194 Belt main body
295 Protrusion

1. An emitter configured to discharge irrigation liquid of a tube when the emitter is disposed at a position corresponding a discharging port configured to communicate inside and outside of the tube, the emitter being configured to discharge the irrigation liquid from the discharging port, the tube being configured to carry the irrigation liquid, the emitter comprising:
an emitter main body including a first surface, a second surface disposed opposite the first surface, and a side surface connecting between the first surface and the second surface;
a liquid intake part disposed in the first surface of the emitter main body and configured to receive the irrigation liquid;
a discharging part disposed in the second surface of the emitter main body and configured to discharge the irrigation liquid;
a channel connecting between the liquid intake part and the discharging part in the emitter main body and configured to distribute the irrigation liquid; and
a protrusion disposed in a part of the side surface.

2. The emitter according to claim 1,
wherein the side surface includes two first side surfaces disposed opposite to each other in a first direction, and two second side surfaces disposed opposite to each other in a second direction perpendicular to the first direction;
wherein a length of each of the two first side surfaces in the second direction is greater than a length of each of the two second side surfaces in the first direction; and
wherein the protrusion is disposed in one first side surface of the two first side surfaces.

3. The emitter according to claim 1,
wherein the first surface is a flat surface; and
wherein a surface of the protrusion on a first surface side is a flat surface, and forms one continuous surface together with at least a part of the first surface.

4. The emitter according to claim 1,
wherein the second surface is a curved surface having a shape identical to a shape of a part of an inner surface of the tube; and
wherein a surface of the protrusion on a second surface side is a curved surface having a shape identical to a shape of a part of an inner surface of the tube, and forms one continuous curved surface together with the second surface.

5. A drip irrigation tube comprising:
a tube; and
the emitter according to claim 1, the emitter being disposed in the tube.

6. The emitter according to claim 2,
wherein the first surface is a flat surface; and
wherein a surface of the protrusion on a first surface side is a flat surface, and forms one continuous surface together with at least a part of the first surface.

7. The emitter according to claim 2,
wherein the second surface is a curved surface having a shape identical to a shape of a part of an inner surface of the tube; and
wherein a surface of the protrusion on a second surface side is a curved surface having a shape identical to a shape of a part of an inner surface of the tube, and forms one continuous curved surface together with the second surface.

8. The emitter according to claim 3,
wherein the second surface is a curved surface having a shape identical to a shape of a part of an inner surface of the tube; and
wherein a surface of the protrusion on a second surface side is a curved surface having a shape identical to a shape of a part of an inner surface of the tube, and forms one continuous curved surface together with the second surface.

9. The emitter according to claim 6,
wherein the second surface is a curved surface having a shape identical to a shape of a part of an inner surface of the tube; and
wherein a surface of the protrusion on a second surface side is a curved surface having a shape identical to a shape of a part of an inner surface of the tube, and forms one continuous curved surface together with the second surface.

10. A drip irrigation tube comprising:
a tube; and
the emitter according to claim 2, the emitter being disposed in the tube.

11. A drip irrigation tube comprising:
a tube; and
the emitter according to claim 3, the emitter being disposed in the tube.

12. A drip irrigation tube comprising:
a tube; and
the emitter according to claim 4, the emitter being disposed in the tube.

13. A drip irrigation tube comprising:
a tube; and
the emitter according to claim 6, the emitter being disposed in the tube.

14. A drip irrigation tube comprising:
a tube; and
the emitter according to claim 7, the emitter being disposed in the tube.

15. A drip irrigation tube comprising:
a tube; and
the emitter according to claim 8, the emitter being disposed in the tube.

16. A drip irrigation tube comprising:
a tube; and
the emitter according to claim 9, the emitter being disposed in the tube.
